(19) United States
(12) Patent Application Publication
(10) Pub. No.: US 2023/0178790 A1
(43) Pub. Date: Jun. 8, 2023

(54) SECONDARY BATTERY AND MANUFACTURING METHOD OF THE SAME

(71) Applicant: LG ENERGY SOLUTION, LTD., Seoul (KR)

(72) Inventor: Hana LEE, Daejeon (KR)

(73) Assignee: LG ENERGY SOLUTION, LTD., Seoul (KR)

(21) Appl. No.: 17/925,154

(22) PCT Filed: May 18, 2021
(86) PCT No.: PCT/KR2021/006242

§ 371 Date: Nov. 14, 2022

(30) Foreign Application Priority Data
May 19, 2020 (KR) 10-2020-0059561

(51) Int. Cl. H01M 10/04; H01M 50/593; H01M 50/242

(52) U.S. Cl. CPC H01M 10/0431; H01M 50/593; H01M 10/0422; H01M 50/242

(57) ABSTRACT

A secondary battery according to one embodiment of the present disclosure includes a jelly-roll type electrode assembly; and an upper end insulating member positioned on an upper part of the electrode assembly, wherein the upper end insulating member includes an insulating layer, and wherein the insulating layer comprises a non-woven fabric that is folded at least once and crimped.

### TECHNICAL FIELD

### Cross Citation with Related Application(s)

This application claims the benefit of Korean Patent Application No. 10-2020-0059561 filed on May 19, 2020 with the Korean Intellectual Property Office, the disclosure of which is incorporated herein by reference in its entirety.

The present disclosure relates to a secondary battery and a method for manufacturing the same, and more particularly, to a secondary battery including an upper end insulating member, and a method for manufacturing the same.

### BACKGROUND

As the demands for portable electronic products such as notebooks, video cameras and cellular phones are rapidly increased in these days, and development of electric vehicles, energy storage batteries, robots, satellites, etc. is under active progress, numerous studies are being made on secondary batteries being used as the driving power source.

The electrode assembly mounted in the battery case is a power generating element, having a cathode/separator/anode stack structure, which can be charged and discharged, and the electrode assembly is classified into a jelly-roll type, a stacked type and a stacked/folded type. The jelly-roll type electrode assembly is configured to have a structure in which a long sheet type cathode and a long sheet type anode, to which active materials are applied, are wound in a state where a separator is interposed between the cathode and the anode, the stacked type electrode assembly is configured to have a structure in which a large number of cathodes having a predetermined size and a large number of anodes having a predetermined size are sequentially stacked in a state in which separators are interposed between the cathodes and the anodes, and the stacked/folded type electrode assembly is a combination of the jelly-roll type electrode assembly and the stacked type electrode assembly. Among them, the jelly-roll type electrode assembly has advantages in that manufacturing is easy and an energy density per unit weight is high.

Such a secondary battery includes, for example, nickel-cadmium battery, nickel hydrogen battery, nickel zinc battery, lithium secondary battery, and the like. Among these, since the lithium secondary battery has the advantages in that it has almost no memory effect compared to nickel-based secondary battery and thus, can be charged and discharged freely, and have very low self-discharge rate, high operating voltage, and high energy density per unit weight, it is widely used in the field of advanced electronic devices.

Based on the shape of a battery case, a secondary battery is classified into a cylindrical battery where an electrode assembly is built into a cylindrical metal can, a prismatic battery where an electrode assembly is built into a prismatic metal can, and a pouch-type battery where an electrode assembly is built into a pouch type case formed of an aluminum laminate sheet. Among them, the cylindrical battery has an advantage in that it has a relatively large capacity and is structurally stable.

Meanwhile, in the case of a cylindrical battery or a prismatic battery, an insulating member may be mounted on an upper end or a lower end of the electrode assembly. The insulating member is configured to maintain an electrically insulating state between the electrode assembly and the conductive parts inside the battery case, and may generally include an insulating material.

### DETAILED DESCRIPTION OF THE INVENTION

### Technical Problem

It is an object of the present disclosure to provide a secondary battery that improves the assembly processability of the internal structure and also controls the fluidity of the internal structure, thus improving safety against external vibration and impact, and a method for manufacturing the same.

However, the technical problem to be solved by embodiments of the present disclosure is not limited to the above-described problems, and can be variously expanded within the scope of the technical idea included in the present disclosure.

### Technical Solution

According to one embodiment of the present disclosure, there is provided a secondary battery comprising: a jelly-roll type electrode assembly; and an upper end insulating member positioned on an upper part of the electrode assembly, wherein the upper end insulating member includes an insulating layer, and wherein the insulating layer comprises a non-woven fabric that is folded and crimped at least once.

The upper end insulating member may absorb the electrolyte solution after being positioned on the upper part of the electrode assembly and thus increase in thickness.

The upper end insulating member may include a heat-resistant film layer formed on one surface of the insulating layer.

The heat-resistant film layer may be formed on the upper surface of the insulating layer.

The heat-resistant film layer may include at least one of high-density polyethylene (HDPE), Teflon, and silicon (Si).

The secondary battery may further include a battery case in which the electrode assembly is housed, wherein the battery case may include a beading part that is indented in the center direction of the electrode assembly from an upper part of the upper end insulating member.

The upper end insulating member may include a heat-resistant film layer formed on one surface of the insulating layer, and the heat-resistant film layer may be positioned between the insulating layer and the beading part.

According to another embodiment of the present disclosure, there is provided a method for manufacturing a secondary battery, comprising the steps of: housing a jelly-roll type electrode assembly in a battery case; preparing an upper end insulating member containing an insulating layer; and positioning the upper end insulating member on an upper part of the electrode assembly, wherein the step of preparing the upper end insulating member comprises crimping the non-woven fabric after folding at least once to form the insulating layer,

The step of preparing an upper end insulating member may further include forming a heat-resistant film layer on the insulating layer.

The step of preparing an upper end insulating member may include cutting the insulating layer and the heat-resistant film layer together.

The method for manufacturing a secondary battery may further include indenting the battery case in the center direction of the electrode assembly from the upper part of the upper end insulating member to form a beading part.

The method for manufacturing a secondary battery may further include injecting an electrolyte solution into the electrode assembly through the upper end insulating member.

### Advantageous Effects

According to embodiments of the present disclosure, the rigidity of the upper end insulating member can be improved through the folded and crimped non-woven fabric, thus improving the assembly processability of the secondary battery. In addition, the upper end insulating member can control the fluidity of the internal structure of the secondary battery, thus improving safety against external vibration and impact.

The effects of the present disclosure are not limited to the effects mentioned above and additional other effects not described above will be clearly understood from the description of the appended claims by those skilled in the art.

### BRIEF DESCRIPTION OF THE DRAWINGS

FIG. 1 is a cross-sectional perspective view of a secondary battery according to an embodiment of the present disclosure;

FIG. 2 is a perspective view of an upper end insulating member included in the secondary battery of FIG. 1;

FIG. 3 is a perspective view of an upper end insulating member according to a comparative example of the present disclosure;

FIGS. 4a to 4c are views for explaining a method for manufacturing a secondary battery according to an embodiment of the present disclosure; and

FIGS. 5a to 5d are views for explaining a step for manufacturing an upper end insulating member according to an embodiment of the present disclosure.

### DETAILED DESCRIPTION OF THE EMBODIMENTS

Hereinafter, various embodiments of the present disclosure will be described in detail with reference to the accompanying drawings so that those skilled in the art can easily implement them. The present disclosure can be modified in various different ways, and is not limited to the embodiments set forth herein.

Portions that are irrelevant to the description will be omitted to clearly describe the present disclosure, and like reference numerals designate like elements throughout the specification.

Further, in the figures, the size and thickness of each element are arbitrarily illustrated for convenience of description, and the present disclosure is not necessarily limited to those illustrated in the figures. In the figures, the thickness of layers, regions, etc. are exaggerated for clarity. In the figures, for convenience of description, the thicknesses of some layers and regions are shown to be exaggerated.

In addition, it will be understood that when an element such as a layer, film, region, or plate is referred to as being “on” or “above” another element, it can be directly on the other element or intervening elements may also be present. In contrast, when an element is referred to as being “directly on” another element, it means that other intervening elements are not present. Further, the word “on” or “above” means disposed on or below a reference portion, and does not necessarily mean being disposed “on” or “above” the reference portion toward the opposite direction of gravity.

Further, throughout the specification, when a portion is referred to as “including” a certain component, it means that the portion can further include other components, without excluding the other components, unless otherwise stated.

Further, throughout the specification, when referred to as “planar”, it means when a target portion is viewed from the upper side, and when referred to as “cross-sectional”, it means when a target portion is viewed from the side of a cross section cut vertically.

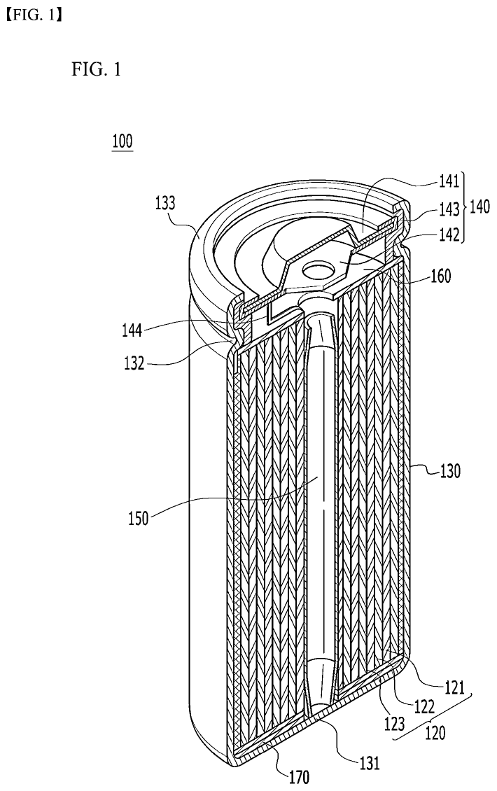

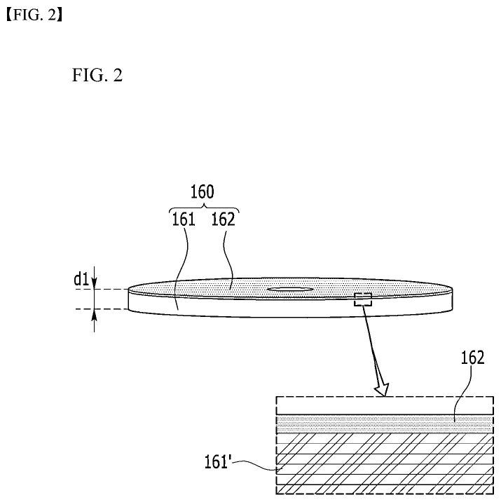

FIG. 1 is a cross-sectional perspective view of a secondary battery according to an embodiment of the present disclosure. FIG. 2 is a perspective view of an upper end insulating member included in the secondary battery of FIG. 1.

Referring to FIGS. 1 and 2, a secondary battery 100 according to an embodiment of the present disclosure includes a jelly-roll type electrode assembly 120 and an upper end insulating member 160 positioned on an upper part of the electrode assembly 120. The electrode assembly 120 has a jelly-roll type structure in which a cathode 121 and an anode 122 are wound with a separator 123 interposed therebetween, and a center pin 150 may be inserted in the central part thereof.

The upper end insulating member 160 includes an insulating layer 161, and the insulating layer 161 includes a non-woven fabric 161′ that is folded at least once and crimped. In order to increase the rigidity and the degree of expansion of the upper end insulating member 160, the non-woven fabric 161′ is preferably folded and overlapped several times. Further, the upper end insulating member 160 may further include a heat-resistant film layer 162 formed on one surface of the insulating layer 161. Specifically, it is preferable that the heat-resistant film layer 162 is formed on the upper surface of the insulating layer 161 and is positioned between the insulating layer 161 and the beading part 132 of the battery case 130 described later.

The non-woven fabric 161′ may include an electrically insulating material, and may be formed by entangling the insulating fibers without directionality. The insulating fiber may include at least one of polyethylene, polybutylene, polystyrene, polyethylene terephthalate, polypropylene, glass fiber, natural rubber, and synthetic rubber.

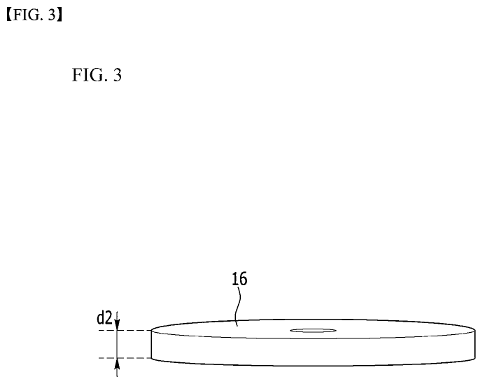

Meanwhile, FIG. 3 is a perspective view of an upper end insulating member 16 according to a comparative example of the present disclosure.

Referring to FIG. 3, the upper end insulating member 16 according to the present comparative example may be formed by perforating a non-woven fabric containing the insulating fiber so as to match with the size or by perforating after compression. Since the upper end insulating member 16 is formed by simply cutting or perforating the non-woven fabric, it does not have sufficient rigidity, and has a problem of being easily wrinkled in the process of forming the beading part 132 of the battery case 130. Further, the thickness d2 of the upper end insulating member 16 may be about 20 mm to 40 mm, and even if the electrolyte solution is absorbed and permeated after being disposed on the upper end of the electrode assembly, the thickness d2 does not change. Due to tolerances in the manufactured secondary battery or the like, there may be a problem that the upper end insulating member 16 is not fixed and is protruded or teared.

On the other hand, unlike this, since the upper end insulating member 160 according to the present embodiment is not formed by simply crimping the non-woven fabric 161′, but is formed by being folded and overlapped several times and then crimped, and therefore, its rigidity can be improved. Therefore, damage such as crumpling of the upper end insulating member 160 in the process of forming the beading part 132 of the battery case 130 can be reduced.

On the other hand, before the electrolyte solution is absorbed, the thickness d1 of the upper end insulating member 160 according to the present embodiment may be 10 mm to 20 mm, which is the half level of the thickness d2 of the upper end insulating member 16 according to the present comparative example. However, since the upper end insulating member 160 is formed by folding and crimping the non-woven fabric 161′ several times, the upper end insulating member 160 is expanded at the time of absorbing the electrolyte solution, and the thickness d1 of the upper end insulating member 160 may increase.

When the beading part 132 is formed, the thickness d1 of the upper end insulating member 160 according to the present embodiment is the half level of the thickness d2 of the upper end insulating member 16 according to the present comparative example, whereby damage applied to the upper end insulating member 160 can be minimized. After that, when the electrolyte solution is injected into the electrode assembly 120, the expanded upper end insulating member 160 can be fixed between the electrode assembly 120 and the beading part 132, and the upper end insulating member 160 is stably fixed. In addition, due to the expansion of the upper end insulating member 160, the electrode assembly 120 can also be stably fixed in the battery case 130. That is, the fluidity of the internal structure of the secondary battery 100 can be controlled through the expanded upper end insulating member 160, thereby improving the safety against external vibration or impact.

As described above, the upper end insulating member may further include a heat-resistant film layer 162 formed on one surface, in particular, an upper surface of the insulating layer 161. Such a heat-resistant film layer 162 is for imparting heat resistance and chemical resistance to the insulating layer 161, which is vulnerable in heat resistance, and may include at least one of high-density polyethylene (HDPE), Teflon, and silicon (Si).

Further, the heat-resistant film layer 162 formed on the upper surface of the insulating layer 161 can minimize the deformation of the shape of the insulating layer 161 containing the non-woven fabric 161′ in the upward direction at the time of injecting the electrolyte solution, can guide the direction of expansion of the insulating layer 161 to the downward direction, and can make the degree of expansion of the insulating layer 161 uniform for each region. Therefore, after that, in a post-process of coupling the cap assembly 140 or the like to the upper end of the battery case 130, the occurrence of defects can be reduced, and thus the manufacturing processability can be improved.

Meanwhile, the electrode assembly 120 has a structure in which a cathode 121 and an anode 122 are wound with a separator 123 interposed therebetween, and a cylindrical center pin 150 may be inserted in the central part thereof. The center pin is generally made of a metal material in order to impart a predetermined strength, and consists of a cylindrical structure obtained by bending a plate material in a round shape. The center pin 150 can serve to fix and support the electrode assembly and can serve as a passage for discharging gas generated by an internal reaction during charge/discharge and operation.

Meanwhile, referring back to FIG. 1, the secondary battery 100 according to the present embodiment may further include a battery case 130 in which the electrode assembly 120 is housed. Specifically, the secondary battery 100 can be manufactured by housing the electrode assembly 120 in the battery case 130, injecting an electrolyte solution into the battery case 130, and then coupling a cap assembly 140 to the upper end of the battery case 130.

The battery case 130 may include a beading part 132 and a crimping part 133.

The beading part 132 refers to a portion where a part of the battery case 130 is indented in the center direction of the electrode assembly 120 from the upper part of the insulating member, and is for stably coupling the cap assembly 140 and preventing the electrode assembly 120 from flowing. Here, the central direction of the electrode assembly 120 may mean a radial direction from the outer peripheral surface of the jelly-roll type electrode assembly 120 to the place where the center pin 150 is positioned.

The crimping part 133 refers to a portion that is positioned above the beading part 132 and wraps the cap assembly 140, which is for stable coupling the cap assembly 140.

The cap assembly 140 may include an upper end cap 141 for forming a cathode terminal, a cap plate 142 to which the cathode tab 144 extending upward from the electrode assembly 120 is connected, and a gasket 143 for maintaining airtightness. The gasket 143 is mounted on the upper inner surface of the crimping part 133 and the beading part 132 to increase the sealing force between the cap assembly 140 and the battery case 130.

Meanwhile, the secondary battery 100 according to the present embodiment may include a lower end insulating member 170 positioned at the lower end of the electrode assembly 120. The lower end insulating member 170 includes an electrically insulating material, and can serve to insulate between the electrode assembly 120 and the bottom part 131 of the battery case 130.

The battery case 130 may be a cylindrical case or a prismatic case, but as shown in FIG. 1, it is preferably a cylindrical case.

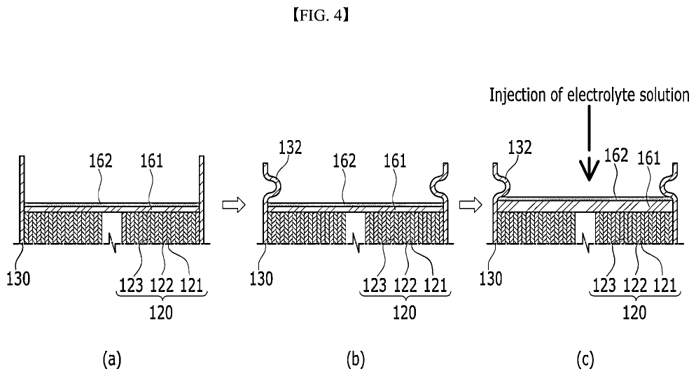

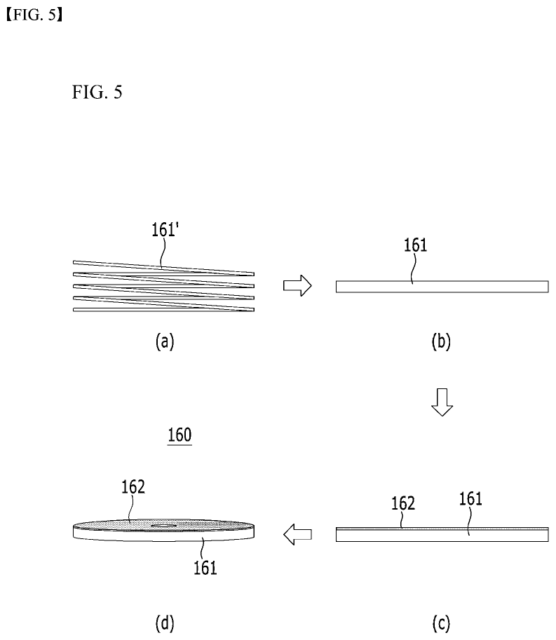

Hereinafter, a method for manufacturing a secondary battery according to an embodiment of the present disclosure will be described with reference to FIGS. 4 and 5.

FIGS. 4a to 4c are views for explaining a method for manufacturing a secondary battery according to an embodiment of the present disclosure. Particularly, a cross-section of the upper end of the battery case 130 in which the electrode assembly 120 is housed is shown.

Referring to FIGS. 1 and 4a, a method of manufacturing a secondary battery according to an embodiment of the present disclosure includes the steps of: housing a jelly-roll type electrode assembly 120 in a battery case 130, preparing an upper end insulating member 160 containing an insulating layer 161, and positioning the upper end insulating member 160 on an upper part of the electrode assembly 120. The battery case 130 may be a cylindrical case with an open upper end, and may house the electrode assembly 120 through the open upper end. The order of each of the above steps is not limited, and the electrode assembly 120 and the upper end insulating member 160 are housed in the battery case 130 in a state where the upper end insulating member 160 is positioned on the upper part of the electrode assembly 120.

FIGS. 5a to 5d are views for explaining a step for manufacturing an upper end insulating member according to an embodiment of the present disclosure.

Referring to FIGS. 5a and 5b, the step of preparing the upper end insulating member 160 may include a step of crimping the non-woven fabric 161′ after folding at least once to form the insulating layer 161. In order to increase the rigidity and the degree of expansion of the upper end insulating member 160, the nonwoven fabric 161′ is preferably folded and overlapped several times.

Thereafter, referring to FIG. 5c, a step of forming the heat-resistant film layer 162 on the insulating layer 161 may be continued. The method of forming the heat-resistant film layer 162 is not particularly limited. For example, the heat-resistant film layer can be formed by a method of overlapping the fabric of the insulating layer 161 and the fabric of the heat-resistant film layer 162 and then perforating them, a method of separately punching the fabric of the insulating layer 161 and the fabric of the heat-resistant film layer 162 and stacking them, a method of perforating the fabric of the insulating layer 161 and the fabric of the heat-resistant film layer 162 using an adhesive, or the like.

Thereafter, referring to FIG. 5d, the method may include the step of cutting the insulating layer 161 and the heat-resistant film layer 162 so as to match with the size and shape of the battery case 130. The cutting may be performed by a perforation. As described above, the upper end insulating member 160 can be manufactured through each of the above steps.

Referring to FIGS. 1 and 4b, the method for manufacturing a secondary battery according to the present embodiment may further include a step of indenting the battery case 130 in the center direction of the electrode assembly 120 from the upper part of the upper end insulating member 160 to form a beading part 132.

As described above, since the thickness of the upper end insulating member 160 according to the present embodiment can be formed to be the half level of the thickness of the upper end insulating member 16 according to the present comparative example, damage applied to the upper end insulating member 160 in the process of forming the beading part 132 can be minimized.

Next, referring to FIGS. 1 and 4c, the method for manufacturing a secondary battery according to the present embodiment may further include a step of injecting an electrolyte solution into the electrode assembly 120 through the upper end insulating member 160.

As described above, as the electrolyte solution is injected, the upper end insulating member 160 according to the present embodiment expands and its thickness may increase. Due to the expansion of the upper end insulating member 160, the upper end insulating member 160 and the electrode assembly 120 can be stably fixed under the beading part 132 of the battery case 130, and thus, the safety against external vibration or impact can be improved. In addition, through the heat-resistant film layer 162 positioned between the insulating layer 161 and the beading part 132, it is possible to minimize the shape of the insulating layer 161 from being deformed in the upward direction and to guide the direction of expansion of the insulating layer 161 to the downward direction.

Although not specifically shown in the figure, the method for manufacturing a secondary battery according to the present embodiment may include, as a post-process step, a step of positioning the cap assembly 140 including the upper end cap 141, the cap plate 142, and the gasket 143 on the beading part 132 of the battery case 130, and a step of forming the crimping part 133 through a crimping step to couple the battery case 130 and the cap assembly 140. The heat-resistant film layer 162 can minimize the shape deformation of the insulating layer 161 in the upper direction and can guide the expansion direction of the insulating layer 161 to the lower direction, thus reducing defects in the process at the post-process step.

Although the terms representing directions such as front, rear, left, right, upper and lower directions are used herein, it is obvious to those skilled in the art that these merely represent for convenience in explanation, and may differ depending on a position of an observer, a position of an object, or the like.

The secondary batteries according to the present embodiment described above can be applied to various devices. Specifically, such a device can be applied to a vehicle means such as an electric bicycle, an electric vehicle, or a hybrid vehicle, but the present disclosure is not limited thereto, and is applicable to various devices that can use a secondary battery.

Although preferred embodiments of the present disclosure have been described in detail above, the scope of the present disclosure is not limited thereto, and various modifications and improvements made by those skilled in the art using the basic concepts of the present disclosure, which are defined in the appended claims, also belong to the scope of the present disclosure.

### DESCRIPTION OF REFERENCE NUMERALS

100: secondary battery
120: electrode assembly
132: beading part
160: upper end insulating member
161: insulating layer
162: heat-resistant film layer

1. A secondary battery comprising:
a jelly-roll type electrode assembly; and
an upper end insulating member on an upper part of the electrode assembly,
wherein the upper end insulating member includes an insulating layer, and
wherein the insulating layer comprises a non-woven fabric that is folded at least once and crimped.

2. The secondary battery according to claim 1, wherein:
the upper end insulating member is configured to absorb an electrolyte solution after being positioned on the upper part of the electrode assembly and increase in thickness.

3. The secondary battery according to claim 1, wherein:
the upper end insulating member further comprises a heat-resistant film layer disposed on one surface of the insulating layer.

4. The secondary battery according to claim 3, wherein:
the heat-resistant film layer is disposed on an upper surface of the insulating layer.

5. The secondary battery according to claim 3, wherein:
the heat-resistant film layer comprises at least one of high-density polyethylene (HDPE), polytetrafluoroethylene sold under the trademark TEFLON, and silicon (Si).

6. The secondary battery according to claim 1,
further comprising a battery case in which the electrode assembly is housed,
wherein the battery case comprises a beading part that is indented in a center direction of the electrode assembly from an upper part of the upper end insulating member.

7. The secondary battery according to claim 6, wherein:
the upper end insulating member further comprises a heat-resistant film layer disposed on one surface of the insulating layer, and
the heat-resistant film layer is positioned between the insulating layer and the beading part.

8. A method for manufacturing a secondary battery, comprising:
housing a jelly-roll type electrode assembly in a battery case;
preparing an upper end insulating member containing an insulating layer, wherein the preparing of the upper end insulating member comprises crimping a non-woven fabric after folding at least once to form the insulating layer; and
positioning the upper end insulating member on an upper part of the electrode assembly.

9. The method according to claim 8, wherein:
the preparing of the upper end insulating member further comprises forming a heat-resistant film layer on the insulating layer.

10. The method according to claim 9, wherein:
the preparing of the upper end insulating member further comprises cutting the insulating layer and the heat-resistant film layer together.

11. The method according to claim 8,
further comprising indenting the battery case in a center direction of the electrode assembly from an upper part of the upper end insulating member to form a beading part.

12. The method according to claim 8,
further comprising injecting an electrolyte solution into the electrode assembly through the upper end insulating member.
